(19) United States
(12) Patent Application Publication
(10) Pub. No.: US 2011/0178440 A1
(43) Pub. Date: Jul. 21, 2011

(54) PALPATION METHOD OF THE PHYSIOREPRODUCTIVE STAGES OF THE UTERUS

(76) Inventor: Carlos Alberto BARCELO ROJAS, Villahermosa (MX)

(21) Appl. No.: 12/892,795

(22) Filed: Sep. 28, 2010

Related U.S. Application Data
(60) Provisional application No. 61/246,167, filed on Sep. 28, 2009.

(51) Int. Cl. A61D 19/00

(52) U.S. Cl. 600/591

(57) ABSTRACT

A method to palpate cows or heifers which includes determining the natural state of consistency of the uterus to determine the size of the uterus to know the physio-reproductive status of the uterus, touching the uterus by sliding the hand on the uterus from the base of the horns towards the tip of the horns to determine the anatomically similarities or differences between the two horns to determine which of the horns is active; and feel the uterus to determine how the active horn reacts.

### REFERENCE RELATED APPLICATIONS

This application is a non-provisional application claiming priority on U.S. Provisional Application No. 61/246,167 filed on Sep. 28, 2009, the content of which is incorporated by reference in this application.

### FIELD OF THE INVENTION

The method of the present invention relates to a method of tactile exploration that interprets the anatomical and physiological status of the uterine horns, as indicators of the preponderant reproductive activity.

### BACKGROUND OF THE INVENTION

The universal model of rectal palpation called uterus/ovarian is a procedure that was developed to meet the conditions of the uterus and ovaries for diagnosis purposes and reproductive therapy. This method symbolizes the different perceptions of the uterus status with a particular emphasis on the pregnancy or non-pregnancy stage of the uterus, specified symbolically with the letter “U” followed by the first letter of the dominant state. Thus, if the uterus is gravid, it is described as UG or UP, gravid or pregnant, indicating with numbers the days or months since conception at the time of the diagnosis. For example, a 5 months pregnant or expectant cow is described as UG5 or UPS.

In the case of a non-gravid uterus, the description of the tone of the uterus is done along with the description of the ovarian status of the female bovine for the purpose of knowing the physiological structures dominant to interpret if a female is at a given time sexually active or not. To interpret the hormonal status for therapeutic and/or zootechnical purposes, in the case of females empty or not pregnant, the first thing to review is the tone and usually this is described as swollen (UT), flaccid (UF), or edematous (EU), and then the found description of the ovarian structures is added. These ovarian structures may be symbolically described with the letter F to follicles, CH for a bleeding body, and CI for a yellow body. The letters are followed by a number that indicates in the case of the follicles, the millimeters of the follicle. For example, a 10 mm follicle is described as F10.

In the case of the yellow body, it is classified as one of two possible perceptions, when it is tender (CH) and when it is ripe (CL), being the condition of CH of a tender corpus luteum that develops during the first half of the estrous cycle, and the CL, to a mature corpus luteum that corresponds to the second half of the estrous cycle. Both cases are also defined with a number that describes the maturity or regression degree, being for CH the numbers 1, 2, and 3 the progressive indicators of their development level, and 3, 2, and 1 to describe the regressive state of the corpus luteum. Thus, we may have the following: CH1 for a newly formed bleeding body characterized on palpation because the lump easily vibrates when touching it, a number two, CH2, where it easily moves but no longer vibrates, and with the number 3, CH3, a bleeding body that moves but resists the movement.

In the case of CL, the same numbers represent the regression state of the corpus luteum when it passes towards a new estrous cycle, being the number 3, CL3, the representation of a fully mature corpus luteum which announces that the animal is in the middle of the estrous cycle. During palpation it feels large and firm, but as the estrous cycle passes, the corpus luteum reduces its size of 3 to 2 and 2 to 1 when a new estrous cycle is imminent. This method, although easily described, is actually very difficult to learn, accurately diagnose, requires many years of practice, and produces many technical errors.

Among the most common mistakes are believing that the calves and cows are sexually active by the mere fact of presenting mature follicles in one or two ovaries. Another mistake is to confuse the presence of corpus luteum, which leads to erroneous therapeutic and zootechnical practices. Another of the great mistakes of the traditional palpation procedure is the nomenclature because while it provides to the specialist the ovarian and uterine status information, the information cannot be used to design handling and feeding strategies of the flock, and to the farmer, does not provide an idea of what needs to be done individually and collectively. In addition, the traditional palpation procedure does not serve to predict the reproductive behavior, since it contains encrypted information that is useless to the farmer.

The traditional palpation method was designed by and for specialists in reproduction. Apart from the fact that it is extremely difficult to learn how to correctly and appropriately diagnose, the method was developed especially for hormonal treatments of various kinds such as cow's synchronization, to trigger ovarian activity, etc. This method has limited utility and cannot provide information on genetic and environmental factors affecting the individual and collective behavior.

There is a need to find a palpation method for cows or heifers that eliminate all the mistakes that presents the traditional palpation method of cows or heifers.

### BRIEF DESCRIPTION OF THE FIGURES

FIG. 1 is a top view showing the location of the uterus in the cow.

FIG. 2 is a perspective side view showing the location of the uterus in the COW.

FIG. 3 shows a perspective front view of the uterus.

The FIGS. 4-8 show different steps of the uterus palpation process.

FIG. 9 illustrates a uterus before puberty.

FIG. 10 illustrates a mature uterus of a heifer.

FIG. 11 illustrates the artificial division of the uterus in three sections.

FIG. 12 illustrates the correct way to feel by rubbing the uterus to stimulate a response.

FIG. 13 illustrates the correct way to position the thumb and index fingers on the uterus.

FIG. 14 illustrates the correct way of positioning the fingers on the uterus.

FIG. 15 illustrates the correct way to cause friction between the tips of the fingers

FIG. 16 illustrates the place the exploration of the second section begins.

FIG. 17 illustrates the correct way to hold the horns in the greater curvature to compare them.

FIG. 18 illustrates the correct way to position the horns to explore the third section of the uterus.

FIG. 19 is a top view showing the location of the uterus in the cow.

FIG. 20 is a side perspective view showing the location of the uterus in the COW.

FIG. 21 illustrates the inlet opening of the cervix.

FIG. 22 illustrates the cervix seen from above.

FIG. 23 shows a front perspective view of the uterus.

FIGS. 24-25 illustrates the steps to maneuver the horns

### DESCRIPTION DETAILED OF THE INVENTION

The palpation method of the uterus physio-reproductive stages according to the present invention is defined as a tactile exploration procedure that examines, analyzes, and interprets the anatomical and physiological status of the uterine horns and the physiological response to the stimulus as indicators of the preponderant reproductive activity. It is a technique that correlates consistency, size, thickness, volume and reaction from the uterus to the rubbing, requires the hormonal status, the ovarian status, the health or disease status of the uterus, and zootechnical status of the animal.

The method of the present invention serves to design feeding and breeding management strategies, to predict the reproductive behavior, and to know the physiological status of the ovarian system for therapeutic or zootechnical purposes.

In addition, the method of the present invention is very easy to learn for anyone who works with cattle, facilitates the understanding of the physiology of reproduction and its nomenclature is used so that the farmer or the staff can design individual and collective handling and feeding strategies.

It is important to understand how the uterus of a female develops from being a calf until it reaches sexual maturity; how the uterus behaves during the estrous cycle; how it is transformed, behaves, and forms during the pregnancy and the postpartum until it is ready to conceive again; changes that occur and how it is possible to detect them easily and with precision. It is also very important to know the tactile exploration technique of the uterus, because the particular way it is carried out allows noticing and assessing the anatomical and physiological development status of the uterine horns. There is knowledge that combines knowing the physiological events that are taking place, which can occur, and in what time, in order to know how to group the reproductive management priorities, feeding, and genetic selection of the herd.

Before attempting to locate the female reproductive organ, it is very important to know where it is located within the cow, to have a mental image and a clear idea to search for it.

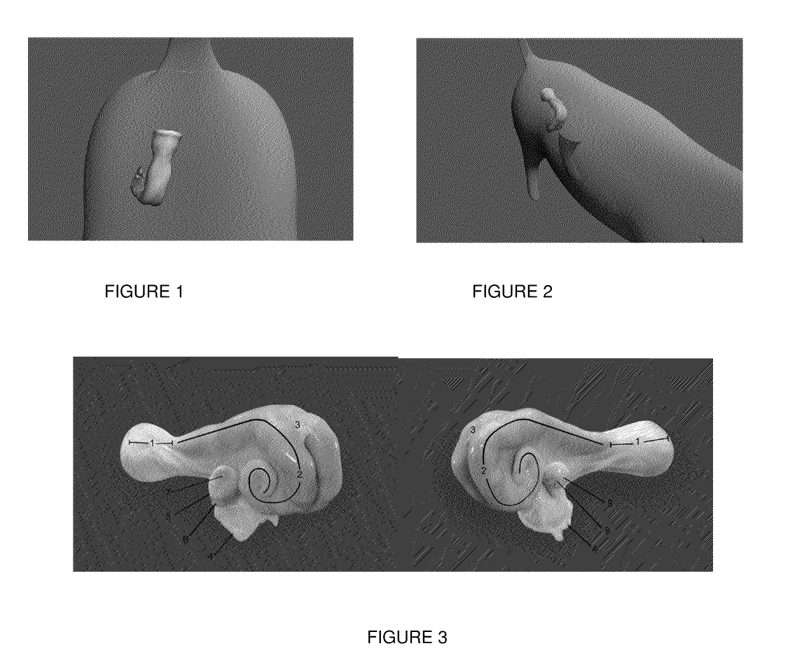

FIG. 1 is a top view showing the location of the uterus in the cow.

FIG. 2 is a side perspective view showing the location of the uterus in the cow.

### Localization and Manipulation of the Cervix of the Cow or Heifer

### General Suggestions

1.—The palpation gloves must be ultra sensitive, and the size, according to the size of the hand, as tight as possible so that plastic excess does not disturb the exploration.

2.—The lubricant can be any oily or soapy substance that allows the hand to slip easily through the anal sphincter and over the rectal muscle wall.

3. Cows must be recently fed, because when they spend many hours without eating, it is easy for the rectum to be filled with air when introducing the hand. When this happens, the rectal muscle distends sticking on the wall of the pelvic cavity, opening a hole that makes it impossible to locate the cervix, or any other part of the reproductive organ.

Introduction and Management of the Left Hand into the Rectum to Look for and Locate the Cervix

The cervix is a tubular structure semi-conic or cylindrical in appearance, formed by a group of cartilage rings having slice shapes of semi-rigid consistency, connected between them by a muscle that, over time, but above all, with the birth is torn apart causing the rings to dislocate deforming the tubular structure.

The size is variable, both in length and in diameter, the truth is that when the animal moves from puberty to adult status, and from this to the multiparous, the cartilage slices grow, they become larger, wider, and thicker, and some are deformed. A very clear example of their form and structure; are the vertebrae and the intervertebral flexibility of an animal tail, that are similar enough to the rings of the cervix, which can be as thin as the tip of the tail, or as thick as the part where it is inserted in the body of the animal. There are three basic elements: 1.—radiated flower. It is the anterior end of the cervix, is usually inside the vagina, is a button which emerges at the bottom of the vaginal cone, forms the anterior end of the first ring, and usually has the inlet opening in its center. 2.—cervical ring, which is a slice of cartilage with a small central hole to intercommunicate. 3.—Intercervical muscle that is a muscle ligament that connects the rings together.

This practice begins with the lubrication of the anal sphincter, to introduce the hand into the rectum, which is easier, if the fingers of the hand are bent forming a tip to penetrate the anus by using force, introducing first the longer fingers through turns to introduce them until the first knuckles, then pushing hard and making at the same time another turn, introduce the hand and let it float, with the fingers extended.

In this exercise, it is normal that the animal immediately tries to expel the hand from the rectum, the introduction leads to a gradual contraction of the intestine to expel the hand and evacuate all of its contents. An event must happen in order to leave the rectum free of manure. Never attempt to palpate with manure in the hand, even with a lot of experience, it is difficult.

Now, once the hand is inside the rectum, the contraction may be so strong that it may expel the hand. When this happens, it is necessary to reintroduce the hand after the evacuation process has ended, the ideal time to do so is when the anal sphincter is contracted for the second time, because it coincides with a relaxation movement of the rectal muscle, which opens a space to introduce and move the hand without generating a new contraction.

On the other hand, when the contraction is not very strong and allows you to leave the hand inside the rectum, it is very important to make sure that the rectum is free of manure, and not to move the hand until the movement, in the opposite direction of the intestine, allows it and feels the hand free floating with the extended fingers, arranged and prepared to make the first search movement where it is believed that the cervix can be found.

At this particular point, it is very important to take into account, that the search, location, and holding of the cervix must be made while the relaxation movement of the rectum is happening, so that at the time that it ends, it is perfectly sustained between the fingers, without squeezing, to avoid new contractions. It is an event, that having the hand inside the rectum, can be clearly perceived, because it pulls inward, and, taking it out, the animal shows it, contracting the anal sphincter several times at the end of the evacuation.

Turn—the Left Hand into the Rectum to Locate and Trap the Cervix

This movement takes place inside the pelvic cavity, a cavity formed by the pelvis bones and spine column, which should be systematically explored, according to their configuration and the possible position of the uterus.

To understand how it is carried out, it is first necessary to imagine that the perimeter of the cavity is divided into twelve equidistant points similar to the distribution of hours of a clock; then, the hand must rotate by the entire perimeter of the cavity, turning counter clockwise, with a similar movement to which would be to open a round lock of a door; Finally, because the desired cervix has a tubular structure, the majority of the time, it is positioned on the pelvic cavity, between six and four hours, so hand needs to be placed with the fingers ready to catch it, with a movement of the hand inside the rectum, which always parts from the center of the highest part of the pelvic cavity, 12 o'clock position, and it rotates counter clockwise.

### First Movement of Search

This first movement is especially important to find the cervix in virgin females, especially in pure or mating females with Zebuin breeds.

First, you need to make sure that the hand penetrates just far enough into the rectum, and that furthermore, it is correctly positioned, without passing beyond where the anal sphincter presses the wrist; with hand floating, touching with the back the top of the cavity, with the fingers slightly curved, open range, in a position to explore the back of the pelvis.

Confirmed the above, will proceed to rotate the hand in the opposite direction (counter clockwise), with your fingers ready and predisposed to feel and catch any piece of tissue that can be found during the turn, it is very common that during the movement around the entire perimeter of the pelvic cavity, the cervix may be placed over the fingers, or hit the palm of the hand. While acquiring experience to detect the cervix, it is very important that during the rotation of the hand, the movement must stop when the index, middle, and annular fingers reach the imaginary point of three o'clock, touching the side of the bone of the pelvis with the finger tips, then the thumb is lowered in an attempt to touch the other fingers, and is almost sure that the cervix will interpose.

### Second Movement of Search

This second movement is only performed when the first movement has failed to locate or find the cervix. This differentiates from the prior, because the hand is introduced a little more inside the rectum, with the anal sphincter by pressing on the arm, between one and two inches behind the wrist. This movement is especially important because it covers in full the search of the cervix inside the pelvic cavity, where the majority of cows and heifers usually have it positioned between the six and four. To locate it will be repeating the same search strategy, rotating the hand counter clockwise and stopping the movement to the three, so with the thumb pushing the cervix against the other fingers.

### Third Movement of Search

The third movement is performed when the cervix is not within the pelvic cavity. It is especially important to locate her inside of the abdominal cavity, in particular, in cows with several births, and very preferably in European dairy breeds.

It begins by introducing the hand enough to touch in its entirety the bone that delimits the abdominal pelvic cavity. It is an exploration movement different from the previous exploration, because the search is concentrated on touching the bone of the pelvis, where you feel a muscle mass resting on the bone. This muscle is the vagina which hangs in the abdominal cavity, which you can take by introducing the index, middle, ring and little fingers below, until it is mounted on the hand and held by those fingers, with the thumb pressing at the top. Then the hand slides forward until you locate and firmly grasp the cervix, to pull it towards its heart, with enough strength to place it on the pelvic cavity.

Finally, and once the cervix is located and trapped, wherever it is, follow how to explore and analyze its size and shape.

### Manipulation of the Cervix

### Positioning of the Fingers to Hold the Cervix

In order to locate the points where the fingers must be accommodated to facilitate its handling, it is necessary to imaginarily divide the perimeter of the cervix, in twelve spaces, as the schedule of a clock's hands, then, the index, middle, and ring fingers must be introduced below the cervix, between the six and the four, holding over the finger tips, to accommodate the thumb finger, pressing on the top of the cervix, between twelve and one, positioning it between the index and middle fingers.

It is very important to bear in mind that the cervix is held over the index, middle, and ring fingertips, and it is held, with the thumb on top, with the hand positioned parallel to the cervical tract. You must keep this position because it makes it easy to explore the cervix, and explore the horns.

It is very important to avoid placing the hand and fingers in a different way, because it limits the movement of the fingers. An unnoticeable mistake that most people tend to commit is embracing the cervix with the hand, stuck to the palm, with the fingers embracing the entire perimeter.

### Displacement of Movements of the Fingers

These exploring movements are made to learn how to move the fingers around the cervix, in order to analyze their shape, symmetry or asymmetry and size, and it carries out, by systematically moving the fingers. To move forward, is beginning to move forward, the index finger, followed by the medium, then, moves the thumb until it is aligned against the index. This movement is repeated as many times as is necessary, to explore all the cervix and feel where it ends, section by section. Then, once the last ring of the cervix has being located, you will hold the slice cartilage between the index and middle fingertip. With the thumb pressing on top, between twelve and one, position backward until you reach the first ring of the cervix, a movement in the opposite direction to the outpost, which is carried out, retreating first thumb finger, and then the fingers below, until aligning the index with the thumb, section by section, is back in this way, until reaching the first ring.

Whether it is to first move them forward and then backward, the objective of this practice is to learn to navigate quickly between one end and the other of the cervix, to acquire the skills necessary to do the sliding of the fingers.

### Exploration and Analysis of the Cervix

This practice has the objective of learning to study and evaluate the cervix. It is a careful analysis of the configuration and plasticity of the cervical structure, as well as the form and distribution of the cervical rings.

The study of the cervix, part of the careful analysis of the regular or irregular configuration, is carried out, sliding the fingers from one extreme to the other, analyzing, the form, symmetry, size, and plasticity. The idea is to learn how to distinguish a regular structure, of one with irregular sinuous shaped, with dislocated rings, or very separate ring between each other by tearing off of the muscle that connects them. It serves to assess the possibility to use or not use an animal in a program of artificial reproduction; it allows to anticipate a possible problem at the time of artificial insemination or embryo transfer; but also serves to give an idea of the possible physio-reproductive state of the uterus; its position and its plasticity, revealing a secret.

After this, follows the detailed exploration of each of the rings, starting with the study of the inlet opening of the cervix, the configuration and conformation of the structure of the first ring; carries out, hooking the first ring between the index finger and middle finger, placed as a scissor holding the cervix, with your thumb free to inspect or direct an instrument you want to introduce inside it.

Then, and only once the first ring has being explored and analyzed, the fingers are rearranged to explore the following. The index finger will be lowered and placed in front of the middle finger, and the thumb will be placed above pressing the cervix, in forward position, to continue with the next ring inspection.

At this point, it is necessary to take into account if the next ring is aligned with respect to the prior if they keep symmetry, whether or not it is separated from the first, and whether or not there is a possible muscle tear between the rings. All of this with only moving the fingers from one ring to the other, moving and pressing at the same time, the thumb against the index finger until that mounts on the slice of the second ring.

In this way, ring by ring, all of the cervix is inspected, and is described with the effort that puts the understanding and applying to know the structure and texture.

Finally, with regard to the cervix, it is necessary that this first lesson is practiced, at least, on 20 cows and 20 calves during the first day. The idea is to learn to recognize the diversity of shapes and sizes, but above all that they learn that the cervix may be placed on the site you want, if the handling is appropriate. It is a practice that should be learned when it manages to locate and hold the cervix during the relaxation of the bowel movement, and when they achieve it, explore it and move it toward the four cardinal points, without generating a new contraction; i.e., when are their movements into the rectum so gentle and careful that the animal allows you to work because it does not feel discomfort.

### Palpation of the Ovaries

The ovaries are a pair of receptor glands and producing hormones associated with reproduction. They are characterized by having within it the heart, an ovum in a latent state, which ripen and develops inside a blister which also grows and develops as the ovum matures. The blister, technically called the follicle of Graff, is a structure that forms for the first time within the ovary by a genetic command that produces a hormone that begins at puberty; It grows and develops accumulating a fluid that is released to induce the slow process of maturation of the uterus, which is carried out during the growth and development of new follicles that are responsible for preparing the uterus to conceive. Then, and only once finished the process of maturation of the uterus, the follicle is responsible for inducing the heat, with which, another hormone genetic command, generates the ovulation process which gives rise the formation of a new structure called the corpus luteum, which grows and develops inside the cavity left by the follicle, releasing a hormone that is responsible for inducing the conception and the maintenance of the pregnancy until their term.

This practice is designed to learn to palpate the ovaries, and to identify the palpable structures, the follicle of Graff, the corpus luteum, and the corpus albicans. The idea is to familiarize yourself with the detection of these structures and the various and grotesque forms that the ovaries take during the process of development of such structures.

During this practice, the farmer, must first locate the ovaries, then, hold them in the appropriate manner and finally feel them. You will have to explore them carefully, looking at the overall consistency of each, the structures found in them and the relationship that keeps these structures with the anatomy and the response to the stimulus of the rubbing of the horns.

There are several ways to locate the ovaries, but in all of them, they must be moved from their natural position to palpate them, because they are floating underneath a muscle called the broad ligament, which prevents direct contact of the fingers with the ovaries, in such a way that makes them seem larger than they actually are, moreover, that makes difficult the correct appreciation of the structures found in them. It is recommended, to accommodate the ovaries out of the zone of influence of this muscle, using a maneuver called the retraction of the uterus, which consists of accommodating the reproductive system in the back of the pelvic cavity. It is done by steps, and the first thing that has to be done is to firmly hold the uterus, with the index finger transversely arranged under the base of the horns and the thumb pressing on the right side of the last ring, in such a way that the palm of the hand holds the contour of the cervix, and the middle, ring and little finger, hugging the contours of the last two rings; then with movement similar to which would be done to bring a cone of ice cream to the mouth, the horns are pulled then lifted, as much as possible, then, without changing the position of the fingers, loosen them and slide them forward until the horns would allow to advance, once again, holding them firmly return to pull and lift the horns directing them to the mouth, and thus, successively, section by section, this movement is repeated as many time as necessary, until the thumb finger is positioned between the two horns on the external bifurcation, which is the point from where begins another maneuver consisting of reaching and firmly grasping the tip of each horn so that from there, starts the search of the ovaries.

Thus, once external bifurcation is reached, is mounted and the index finger or the middle finger are inserted between the two horns, and engaging the bifurcation, is pulled backwards, until the uterus allows, without abuse of force. Then the bifurcation may be released, and the index, middle and ring fingers are mounted on the left horn, slipping them on the left side, following the natural curvature of the horn, until where it feels that it approaches the tip, then, with the index and thumb fingers, the place which was reached will be embraced, and holding it firmly then pull backwards, towards his heart until it is withdrawn and the horn is placed on the top of the uterus, then, with a twist of the hand in the sense of the hands of the clock, is positioned with the tip inverted, then, with a similar movement as to penetrate a hole, depth on the left side of the horn at different points and at various depths until you find the ovary.

However, the easiest way to locate the right ovary is traveling the right horn to get as close as possible to the tip, to pull it until it can be positioned inverted. It is a maneuver that begins once the uterus is retracted and accommodates in the back of the pelvic cavity, pulling by the bifurcation; is achieved by first inserting the index and middle fingers below the horn to sustain it, transversely arranged, slightly separated to position above, in the middle of the two, the thumb fingertip, then systematically moving the fingers, sliding first the index, and the middle, thus when moved, lift the horn, and then, move the thumb towards the index, holding the place that was reached to pull backwards, as trying to take the horn in direction towards the mouth, then it will advance forward, repeating this step section by section, until getting as close as possible to the tip. Once that is achieved, the place that was reached is held between the index and middle fingers, and without drop, turn the hand 180 degrees clockwise, for later, pulling the tip towards the heart until it is removed and placed on top of the uterus; then, with another turn of 90 degrees counter clockwise, the inverted tip is accommodated, and with a similar movement to enter a hole, enter on the right side of the horn at different points and at various depths until you find the ovary, which once is felt and caught, needs to be held in the appropriate manner, hanging index, middle, and thumb fingers, evenly arranged around the ovary, holding them loosely so that the cow does not feel discomfort.

Finally, it will be explained, how to touch the ovary to identify the structures found in them. This is done, by sliding the fingers without pressing the ovary contour, and studying the surface so that, where a change in shape or consistency is felt, first the difference will be analyzed in relation to the rest of the surface, then will be verified with the index finger, especially what is believed to be felt, then following with the thumb finger, because it is often confused the understanding with the imprecise information.

During this practice, each ovary must be carefully explored, analyzing and comparing the overall consistency between the two, and also the structures found in them, and the relation of these structures with the anatomy and the response to the stimulus of the rubbing of the horns.

From the palpation point of view, the Graff follicle is a soft and elastic blister that emerges on the ovary surface, giving it, at the place where it is, rounded aspect, because its structure is developed within the ovary and is round. For its part, the corpus luteum, is a bump that as is developed emerges as a volcano on the ovary surface; it is soft and flexible at the beginning of its development, and becomes semi-rigid as it is maturing; It is characterized because it deforms the surface where is located, whatever is the particular form of the ovary. Finally, the albicans body will be described, a structure that is often confused with a functional corpus luteum, because a scar from an aged corpus luteum that was not reabsorbed during the natural process of re-absorption, is characterized also, as being a structure of volcanic appearance, only that in this case, the lump is completely rigid.

### Handling and Feeling of the Horns

### Palpable Anatomy of the Uterine Horns

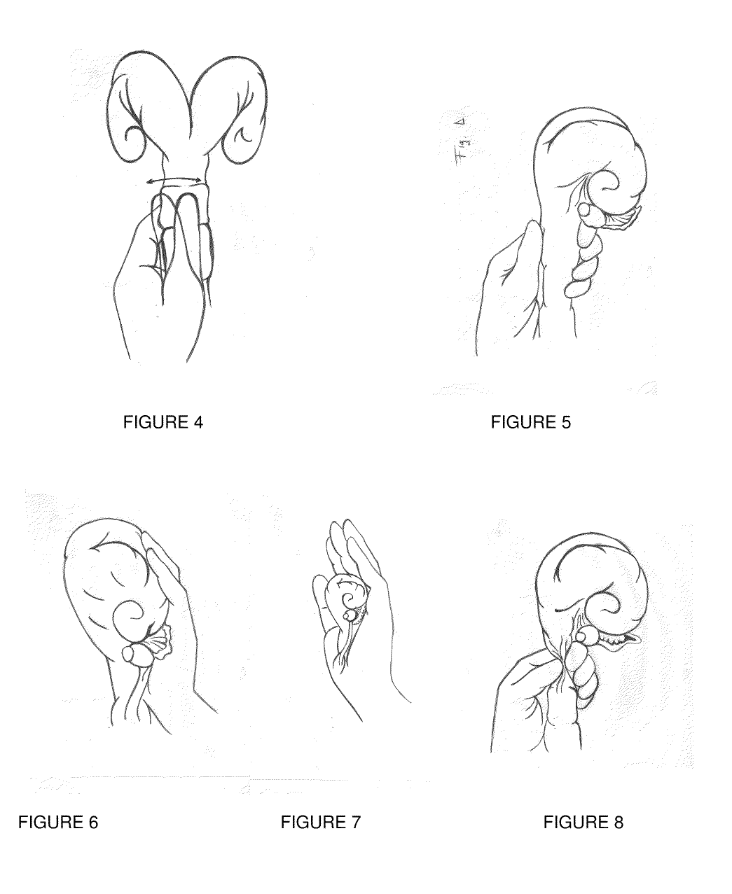

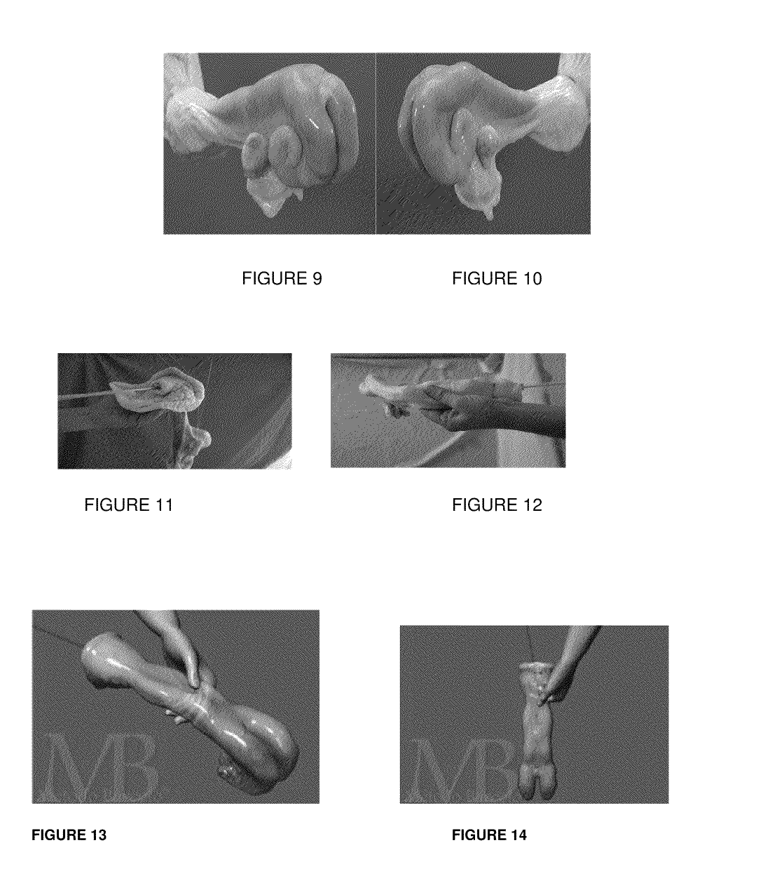

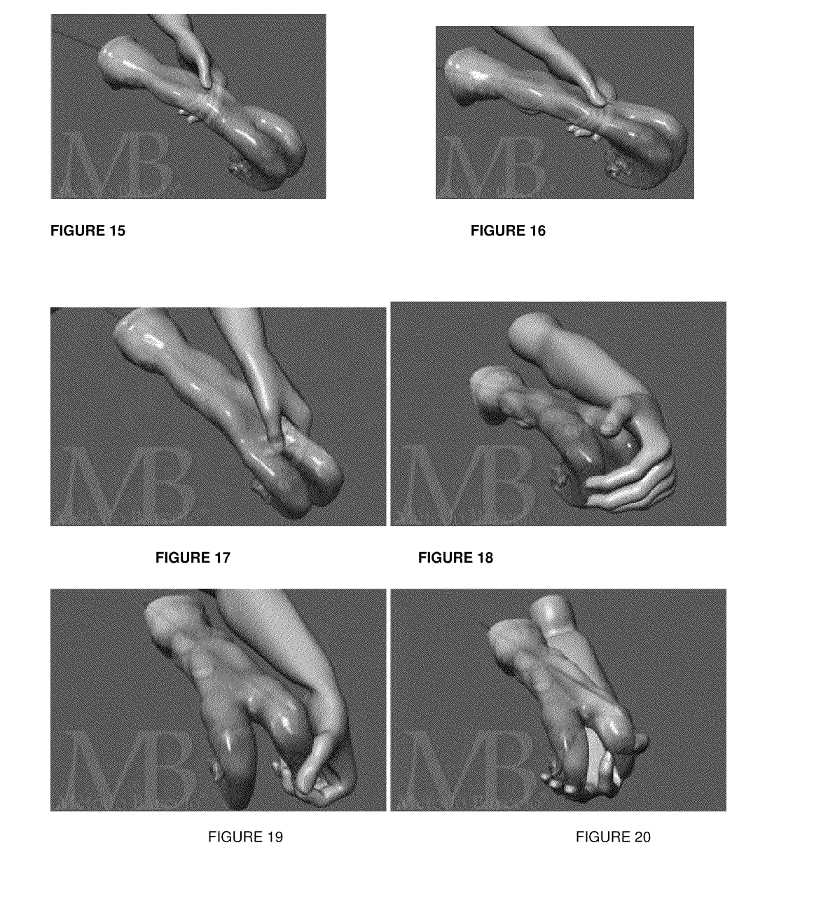

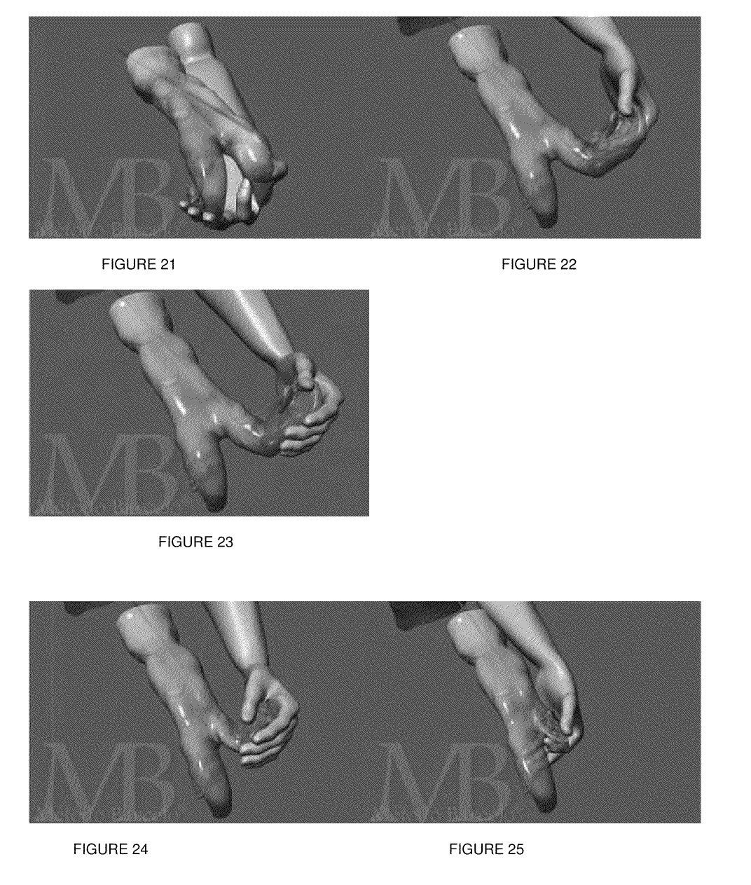

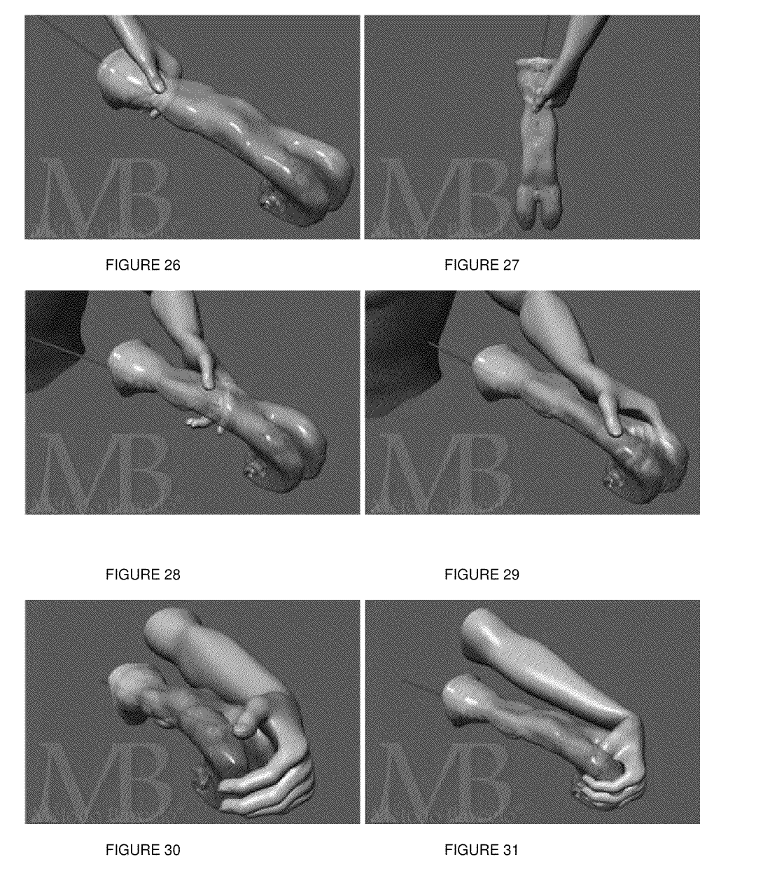

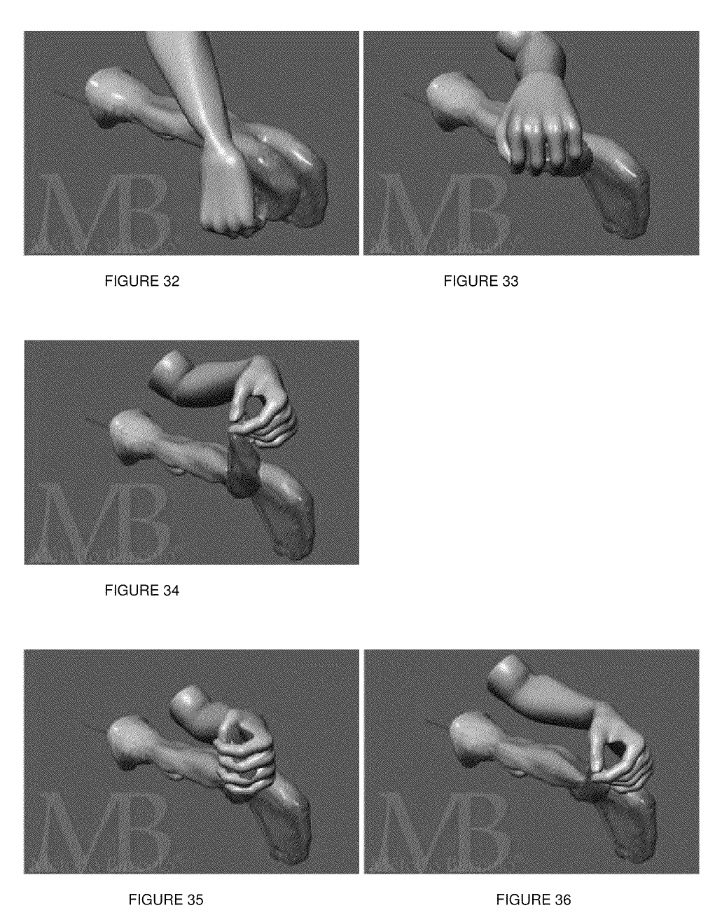

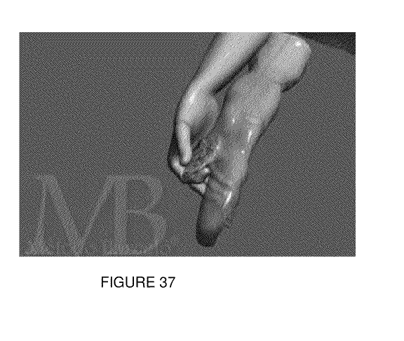

FIG. 3 shows a perspective front view of the uterus. The uterus includes cervix 1, uterine horns 2, the external bifurcation of the horns 3, the oviduct 4, the right ovary 5, the corpus luteum 6, the follicle Graff 7, the left ovarian 8, the primary follicles 9. This utero clearly shows the entire structure of the uterine horns, from which they are start adjacent to the cervix (area clearly differentiated by the color change), to the tip.

From the point of view of palpation, the uterine horns are a pair of semi-conic tubular structures that are usually coiled on itself. They are formed by a muscle that, depending on the degree of maturity of the uterus, may be flaccid, of thin wall, or of thick wall with tense aspect, and flaccid after the ovulation ends. For its study, the uterine horns are divided into two sections, subdivided among them on the external bifurcation, a point that serves as a reference to explain the art of palpation.

The first section is the base of the horns, where the cervix ends to the external bifurcation where they separate, comprising the uterus section where the horns are linked together; and the second section, includes, from where bifurcation is separated until they are joined with their respective oviducts.

This practice is done by positioning and moving the fingers in a similar way as the way that the cervical tract was done. The starting point for exploring them is the base of the horns, a place that helps in locating them because the fingers rest in it, as soon as leaving the last ring of the cervix. To this end, and only while gaining experience, you have to be sure that the fingers are in the right place, doing a test consisting of pressing the thumb fingertip against the index fingertip, to verify, at the time of trying to rub the fingertips against each other, if there is a muscle interposed which prevents that they can be touched directly.

Checked the above, it will begin the advance, always sliding first, the index and middle fingers to lift and accommodate the horns, then, thumb is moved until it aligns with the index.

Once pass the first section, the movement will be repeated until where the uterus allows it to do, because a point will be reached where the movement cannot progress. When this happens, the strategy radically changes, advanced movement becomes more dynamic, the hand with the fingers below are semi-extended in diagonal, slide forward with more energy, as trying to get to the next point in a single step, as quickly as possible, then, once moving in the first section in this way, the place of the uterus which was reached will be firmly held, strongly pulling backwards, lifting the uterus as if they tried to move towards the mouth, to a point where the hand is positioned as if it was holding an ice cream cone pointing to the mouth.

With this maneuver, the uterus is removed and exposed for the feeling, and although you do not feel, it hangs on the other side of the fingers, to move forward, the fingers below will only extend once again, to return to vigorously slide the hand forward to reach a new point on the uterus, which must be again strongly grasped to pull back again raising the uterus until it points to the mouth.

This maneuver of pulling, lifting, and moving forward, must be repeated as many times as necessary until reaching the bifurcation. It is especially important in dairy females with several births, given that the majority has very long horns hanging in the abdominal cavity. It is a movement that must be repeated to ensure reaching the external bifurcation, which may be easily noticed, because when reaching the place, can be clearly felt how the thumb meets the index, with nothing that obstructs the direct contact between them.

The way of making sure that it is the bifurcation, and not in another place, is returning the fingers until mounting again on the horns, feeling, and of new account, how a muscle interposed between the fingers. Another way to verify that it is in the right place, is moving toward the left hand with the thumb and index fingers barely making contact, slightly touching so that at the time of movement with a simple twist of rotation of the wrist to the left, a way to the horn is open, feeling how it stands between these fingers.

This maneuver for exploring the first section of the horns, may need to be practiced many times in different animals, until it can be done without too much effort, until you may slide the hand from the cervix to the bifurcation, of a single pull or movement.

Thus, and only once you learn how to easily slide to the bifurcation, the next step is to explore the second section of the uterus, from external bifurcation, to the tip of the horns.

To do this, the index and middle finger may be transversally accommodated under the bifurcation, slightly separated, holding both horns, then, the thumb may be introduced touching the fingers below, as it is in this position, and from this place, where begins another maneuver designed to mount the fingers correctly on the horns. Includes rearranging the bifurcation, the index and middle fingers position, swerving left, until the fingertips may be positioned against the thumb, closing a clamp around the left horn, then thumb may be slid to the left to mount on the horns, and then moving to the left the index and middle finger, until it may be felt that it holds from below the horn, transversely arranged, slightly separated, opening a space for position above, in the middle of both, the fingertip of the thumb, thus, is in another position, that may be arranged to explore the horn on the same way as it was done in the in the first section of the uterus, moving the fingers systematically. First, the index and the middle finger may be slid, in a manner such that to move them, the horn is lifted up, and then the thumb may be moved to where the index is, holding in this step, the place that was reached; then this movement is repeated, section by section, until the tip is reached, which must return to the bifurcation, moving in the opposite direction the fingers, i.e. first retreating the thumb, and then the bottom fingers, until aligning the index with one.

This practice, like all others, may be repeated many times until acquiring the ability to scroll forward and backward in a single movement around the horn.

Now, with regard to the mounting of the fingers on the right horn, is also part of the positioning of the fingers on the bifurcation, only that in this case, the movements to mount are very different, starting, because in this case, the thumb finger may be placed between the two horns, the deepest possible, to be used as a lever to lift the right horn, with the back of the fingernail. To this, it is necessary that the thumb finger be positioned in the middle of the fingers that transversely hold from below both horns, then rotate 90° the hand in the direction of the hands of the clock, pushing with the thumb the fingers below until all stay in vertical position pointing down. Then, thumb may be rotated in reverse at the hands of the clock, then, the lever may be made to lift the right horn, until it is mounted on the back of the fingernail, and then, the thumb may be hit against the pelvis bone, lifting the horn as high as possible to open a space to accommodate the index below the horn. Later, the thumb may be removed and may be extended on top of the horn, until the fingertip of the thumb reaches the fingertip of the middle, embracing, and the right horn. Finally, the fingers may be rearranged to explore the horn, then the index and the middle holding it, in position to move in the same way as was done with the left horn, systematically moving the fingers back and forth though the horn.

This practice, you must repeat as many times as necessary until switching horns is easy, and that it can easily move forward and backward, at will, by any of the horns. If for some reason it may be felt that it cannot move to the tip of the horns, it is necessary to take into consideration another small maneuver, so-called, retraction of the horn, which consists of pulling back the horn, departing from the place that was reached after being mounted. It carried out, by first firmly holding the horn between the thumb and index fingers, then pulling back to the possible extent, to then to lift it as trying to take to the mouth, and once in this position, the fingers may be moved as previously explained, by first moving the index and the middle, then the thumb, to accommodate it, aligned with the index.

### Manipulation of the Horns for the Palpation of the Oviducts

### Palpable Anatomy of the Oviducts

The oviduct is a tubular structure similar to a string that intercommunicates the horn with the ovary. From the point of view of palpation, its importance lies in the diagnosis of the chronic diseases that are no longer displayed in the horns. In health state is characterized because both have the same diameter and the same texture, except when the animal is in heat, because the hormone excitation stimulates and thickens the oviduct which is going to receive the sperm and the ovule. On the other hand, the disease status is easily distinguished because the ill side is thicker, and becomes semi-rigid.

During this learning phase it is recommended that while trying to feel the oviducts, start studying the ovaries, whenever it is possible to casually touch and hold them; the idea is to begin to familiarize with the different shapes and sizes. Also, with any structure that arose to the surface. For this, it is essential to correctly hold the ovary, between the thumb and the index and middle finger (FIG. 4), opposite, in a similar manner as has been done to explore the horns, holding without squeezing them to avoid pain, in such a way that the fingertips may explore the surface searching for follicular blisters and bodies luteum. The specific palpation practice of the ovaries will be seen below, once you have learned to correctly explore the uterus, to acquire the subtlety and delicacy necessary to move, accommodate and raise the fingers correctly.

This practice consists of a series of maneuvers that have the objective of lifting the horns with the tip inverted, so that the oviducts may be totally exposed. Each Horn is handled differently, but for both, part of the positioning of the hand on the horn curvature. To do this, first the thumb must be arranged above the point where the external bifurcation begins, and the index and middle fingers, below the bifurcation, transversely arranged, holding both horns, as pretending to hug them; then, the hand may slide following the natural curvature of the horns, until the point where it clearly feels that they separate, then, it will continue with the following:

Start with the left side, detailing the maneuver that needs to be done to expose the oviduct. Start with placing the hand hugging the left horn, a maneuver done by sliding the hand to the left, until placing the index, middle, and ring fingers, over the horn contour, positioned to move, following the natural curvature until the thumb with the index, reach the tip or the closest point to it, firmly holding to pull in the direction of the heart, until the horn may be removed and placed on the top of the uterus, then, with a turn of the hand in the sense of the hands of the clock, leaving positioned with the tip inverted and the oviduct exposed to take it with the index and thumb fingers, which is carried out following the tip of the horn to where it joins with the oviduct, to start the touching, moving forward and back as much as possible as allowed by the cord.

Now, the maneuver to expose the right oviduct may be explained, manipulating the horn on the same side. There are two ways to facilitate this operation: the first part where you clearly feel the separation between the horns, is made, by interposing between them, the hand with the fingers extended, touching with the palm the right horn, then gets a little deeper in the direction of the tip, until feeling that rests on the fingers, so it may be pushed upwards, along the side, until it manages to invert the natural position of the horn, with the tip above, on top of the uterus, in a way that may not easily return to its natural position, to give time to take the hand and grab from above the tip, taking it firmly between thumb and index fingers, to pull in direction to the heart, until it is sure that the horn is completely inverted, for this position, drags the oviduct and leaving it exposed for the exploration and analysis.

The other way of manipulating the right horn to expose the oviduct, is carried out with another series of maneuvers. The first is to embrace the horn sliding the hand until the index, middle, ring, and little finger surround it, and until the thumb may be accommodated between the horns, trying to contact with the index finger. In this way, closes a gripper that embraces and secures the horn, arranges in a way that may allow it to slide the hand following the natural curvature until it is possible to advance forward, as close as possible to the tip, because it facilitates and ensures the success of the next maneuver. That is, first to secure the site of the maneuver, pressing without compressing the thumb against the index finger, and then, turning the hands of 180° in the sense of the hands of the clock, maneuver that intends to accommodate the horn next to the palm at the end of the turn, to engage it to the curved fingers, and to continue to the tip, where with the help of the thumb and the index fingers, may be firmly held to pull in the direction of the heart, until the horn is lifted, and accommodates the tip inverted, thus exposing the oviduct for the exploration and analysis with and through the index and thumb fingers, moving them in the same way that was done to move forward on the uterus systematically, section by section, where it will be possible to move forward.

This practice of lifting the two horns to expose, explore, and analyze the diameter and the texture of the oviducts, should be done as many times as necessary, until dominating it with expertise, which will make it possible to easily catch and manipulate the ovarian.

The first thing we need to know is what happens in the uterus of a growing calf until it becomes a heifer which enters into heat for the first time in her life. And what happens physically is that dimensions in length, thickness, and thickness of the horns change, being the uterus of a calf, small, with thin and floppy membranes, and the uterus of a heifer, much larger with the walls of the horns swell. (FIGS. 6 and 7 respectively).

Carefully note the differences. The same way, different size, and very different things that may be felt by touch. The idea is to imagine everything that has to grow and develop before being ready to conceive, because the womb of a virgin female that starts the path of puberty, develops gradually, both horns grow slowly at the same time and in the same proportion, by elongating and swelling the muscle that makes up the uterus by sections, always symmetrically.

This development process, which in the future will be called maturation of the uterus, is the physical manifestation that is taking the uterus as being prepared to conceive. Is triggered when the ovaries are stimulated to cyclically develop follicles, as they are the one that release follicular liquid to induce maturation, which starts at the base of the horns only after many follicles have done the same, slowly to the passing of the months each part matures, thickening the wall at the same pace and time which starts to grow in symmetrical sections in the direction to the tip.

This particular form to mature of the womb of a virgin female, lets you know how much of the uterine horns has been developed and how much they need to develop, to have the approximate time that will take to complete their development, because of this and due to the classification of the degree of maturation of the uterus via palpation is done interpreting how much the uterus is developed or not.

The uterus may be the imaginarily divide for its understanding in three sections. The first is the section between the base of the horns to the external bifurcation thereof, the part of the uterus where the horns are together; the second is the section that includes the horns from which are separated in the external bifurcation until they are to joined to their respective oviducts; and the third, the section comprises the oviducts.

Thus, it is time now to find how we classify the degree of maturation of the uterus of a female which is in process of sexually mature, in order to be able to symbolically express the current state and the time that it may take to be ready to conceive.

### Physiological States of Heifers Sexually Inmatures

During this practice, it is very important that you touch the ovaries, every time that they come to the hands on their own, to familiarize with the different shapes and sizes, as well as, any structure that shows on the surface. For this is essential to place the index and middle fingers opposing to the thumb, in a similar way to how it has been previously done to explore the horns, taking them, without squeezing them, because it is painful, so that the fingertips may explore the surface, in search of follicular blisters.

In general terms, a virgin female who has not reached sexual maturity, may have only two possible cervical palpable scenarios:

(1) Sexual immaturity. The uterus is very small and flaccid, and does not react to manual stimulation. It is so small that it fits in the palm of the hand; its walls are so flaccid and thin that it can be felt as a double membrane when rubbed between the tips of the forefinger and the thumb. This membrane tapers as we move towards the tip, guided only by the fold on the edge of the horn. We call this physioreproductive state the Prepuberal Uterus, and we express it symbolically with the acronym UPRE. It is an indicator of a lack of sexual activity. It helps to evaluate the genetic capacity of a female to reproduce based on its age or feeding and the environment it lives in.

(2) Puberty. This is the progressive status of maturation and development of the uterus characterized, because it sends signals of sexual activity expressed through manually induced erection. It is a stage of constant growth classified in three phases or degrees of maturity, each one closely related to the section or sections of the uterus that are in the maturation process.

The first one, symbolically called UPRO1, refers to a proactive uterus in which follicular activity has begun in the first section, the area between the base of the horns and the external bifurcation. It indicates that there is still a long way to go to finish the preparation of the uterus to conceive, that it will take at least six months to achieve sexual maturity according to the particular feeding, care, and handling conditions to which the heifer is subject to. This is easily detected and recognized during palpation because the initial contact of the hand on the uterus, when trying to locate it, shows a flaccid organ that, when sliding the fingers back and forth over the surface of the uterus, between and above the horns, transforms its flaccid aspect into a tubular structure. As it forms, it shows a small, semi-erect uterus that fits comfortably in the palm of the hand; a uterus that, when explored in detail, at the first attempt to rub at the base of the horns, the area commonly called the base of the horns, the fingertips of the thumb, the forefinger and/or the middle finger can rub until the erection and the tubular shape of the uterus prevents this throughout the whole section that has matured.

The following stage of development, symbolically named UPRO1-2, also refers to a proactive uterus, but in this case the degree of sexual maturity has reached the second section, extends beyond the external bifurcation, but does not reach the tip. It is a stage very similar to the previous one in which it is at rest: a flaccid organ, but in this case, when rubbing it continuously, it erects and forms a tubular structure that may not fit comfortably in the hand, and that also when rubbing thoroughly from the base of the horns, the force of the reaction causes the formation of a tubular structure strong enough to prevent the fingers from rubbing the part that has matured, until reaching a point of the horns where we clearly feel that the tubular structure weakens. In such a way that the fingers can freely rub again the section that delimitates the mature from the immature. This is a point that helps in estimating the progress of the maturation process and the time it needs to finish preparing the uterus for conception. Thus, based on the division of the uterus in sections, and the experience of many years and cases, the development of the uterus can be calculated in spans of time between one and six months, always depending on the point where the formed tubular structure prevents the fingers from touching each other. Therefore, as a rule of thumb, each half of each of the first two sections represents a development period of three months; so every sixth of a section equals one month. For example, when the progress of maturation reaches the mid-point of the larger curvature of the horns, the half of the second section, three months is the average time to complete development.

The third stage, refers to the physiological state preceding sexual activity, it is symbolically catalogued with the term UPRO2. It indicates that the animal is ready to go into its first oestrus within the next 30 days because the uterus only needs to mature the tips of the horns and the oviducts. This state is easily recognized during palpation because, when trying to locate it, simply by touching it produces a violent erection that presents a uterus that no longer fits in the hand, and that the sole stimulation of holding it keeps it erect. It is a state that, when rubbing in detail, we will find that the only part of the horns where the fingertips can rub each other is the tip of the horns, specifically the area where only the tips of the fingers can fit.

### Physiological States of Sexually Inmature Cows

This practice is designed to learn to evaluate the temporal anestro, when the cows have problems to reproduce because of by inadequate feeding, by inheritance, or by living at inhospitable environment. During this practice, it is essential to feel the ovaries, because at this stage of maturation of the uterus only may include follicles and scars of old luteum bodies, inactive, so-called albicans bodies, which often confuse the farmer, the status of maturation of the uterus is not established.

Proactive uterus (UPRO). This physiological state of maturation of the uterus is characterized because the horn that held the gestation reacts at least partially to manual stimulus. The other horn may or may not react, but is always smaller. This physiological state indicates the stage of maturity of the uterus of the cow. It differentiates from heifers because cows do this by maturing a horn independently from the other. It helps to measure and predict the time it will take for the cow to be ready to reproduce again. This status is represented with a symbology closely related to the activity of one of the two horns.

Thus we have UPRO1 referring to a uterus with only one active horn that may react to rubbing entirely or partly. This is characterized by the great size disproportion between the horns, in which the active one is much larger and the only one that reacts to rubbing, at least in one section. The inactive horn does not react; it is very small, flaccid, and thin-walled. This post-partum status indicates the female will not be ready for conception until the end of lactation. It also indicates that its feeding conditions do not allow it to reproduce efficiently or that it is genetically incapable of doing so

UPRO1-2 refers to a uterus with a horn that reacts through its full length and the other one only in part. The disproportion of the horns is clearly evident, but less notorious than in the previous status because the smaller horn is also in its maturation process to reach the size and width of the larger horn. This status is detected through palpation because when the smaller horn is rubbed, it only takes on its tubular shape in the mature section, while the immature part shows a thinner wall, no response to rubbing, and a flat-shaped horn.

In general, these two variables of the physioreproductive statuses of the proactive uterus indicate a latent reproduction status propitiated by a slight nutritional imbalance or, in some cases, by a genetic inability to reproduce in the environment it inhabits. This is a behavior pattern that serves as a reference for genetic selection oriented to biological efficiency.

Lastly, we will describe the physioreproductive status of the uterus when the cow goes from proactive to the status preceding the oestrus: UPRO2. This is a successive and progressive status that all females that have given birth must reach to be able to conceive again. Its characteristic is that when the uterus is touched while being located, an immediate erection is obtained and maintained simply by holding it in the hand. This is a status physically manifested when the horn that was developing is about to reach the same size as the horn that matured first. Both horns react to rubbing with an immediate erection, and the smaller horn only needs to mature its tip—the end of the horn where only the fingertips fit. It is felt by palpation because the wall is thinner and when rubbed, allows the tip of the thumb to touch lightly upon the tip of the forefinger. This status is a clear indication that the physioreproductive activity of the female is about to complete the maturation process of the uterus and that it is about to go into oestrus within the next 30 days.

### Physiological States of Heifers and Cows Sexually Mature

During this practice you must know what happens in the uterus, once it is fully mature when cyclical sexual activity is triggered. It is equally important to feel ovaries, studying the ovaries shape, size and structures, follicles and luteum bodies. The idea is to learn how to correlate the status of the uterus with what is happening in the ovarian system.

It is important, before continuing with the study of the behavior of the uterus in a sexually active animal, to touch on another very important theoretic aspect: The estral cycle. This is the natural biologic cycle that induces reproduction through the manifestation of uncontrollable sexual desire caused by a physio reproductive mechanism that ensures that the ovule is released right after the cow or heifer has copulated with the male. The idea of knowing this technique is to know that in each cycle, a follicle grows and ovulates, and at the place of grow up and ovulation, develops and shapes the corpus luteum, a structure that takes its place, but performs another function. It is born after the follicle empties and the orifice it left closes. The corpus grows slowly after hours and days until it fills the follicle cavity that brought it to life. Then, if the animal does not get pregnant, it slowly reduces in size, until it disappears when the cycle ends; generally when the ovulation process of another follicle formed and developed in the other ovary while the corpus luteum grew and was re-absorbed.

This is a cycle that tends to be constant in most animals, and irregular in the minority, but both cases are delimited by the appearance of a new oestrus that signals the beginning of a new oestral cycle in which the functions of ovaries alternate. This is, the ovary that, during the last cycle developed a follicle will develop a corpus luteum in the new cycle, while the other ovary develops a new follicle. But beware, it does not happen this way in all cows since there are two ovarian genotypes where only one of the ovaries is functional and where both physiologic structures grow and develop: One that embraces cows with only one functional ovary during their complete life, and another, embracing cows with an active ovary and the other in latent state.

Sexually active uterus—is when a heifer which is in the first heat or who has entered the heat at least once. It corresponds to a mature uterus that may be in any of the four physiological states of the estrous cycle, which are recognized and differ by the response or reaction of the uterus to the manual stimulation, and the configuration of the horns.

The first described, which corresponds to the state of the heat, UC, correspond to the changes of the uterus during the time that the female remains receptive to copulation, and the time that it takes to ovulate. When the female is declared in heat, the uterus is characterized by its natural flaccid, who at the time of rubbing with the fingers of the hand sliding consistently over and between the horns, responds quickly, excited with an erection showing a tubular uterus, coiled, and symmetrical, that when conformed, does not allow the tips of the fingers to rub each other, and does not fit on the hand. Also, is characterized because if the stimulation stops, leaving resting, the uterus relaxes, and passes from erect to flaccid again, allowing, at the time, to be carefully examined, rubbing part by part the horns between the thumb, index, and middle fingers, and the fingertips to rub the uterus without effort. It is a period during which, the erection induction by manual stimulation of the uterus, moves from violent to the beginning of the heal, to slow towards the end of it; It is also, a period during which the horn, which will nest a new life, begins to increase in diameter as the end of the heat approaches, being more obvious towards the end.

Later, once the heat ends and begins to run the necessary time for ovulation, the uterus gives a turn in the performance; the manual stimulation of the rubbing again generates a very strong and quick erection which stays with just rubbing a part of the uterus. This way of behaving, continues as the follicle matures preparing for ovulation, because when you start to prepare to evacuate the egg, it changes again his behavior, basically because an erection no longer maintained with the mere act of rubbing a part of the uterus, and because the horns already do not form the perfect tubular shape, they begin to acquire flattened shape, allowing, in addition, the friction of the pads of the fingers with each other.

The stage following the oestrus is one of total flaccidity that indicates an oestrus that occurred no longer than five days ago, and up to eight in animals with very long oestral cycles (24, 25, or more days). This status is symbolically represented as UCR. It is noted because the uterus appears shapeless; the muscular texture is totally relaxed, up to the point of feeling like a flaccid membrane that, when rubbed intensely, barely shows its two-horn configuration with symmetric horns, slightly flattened, and does not respond with arousal to intense rubbing, nor forms a tubular shape.

The next stage of the uterus in the oestral cycle is when it begins to react to manual stimulation with a slow erection. This is recognized in palpation because the uterus is felt as flaccid upon first contact with the hand, and only after rubbing repeatedly back and forth over and between the horns it does begin forming a tubular structure that separates the fingers rubbing it. This stage is also noted because if you stop rubbing, the complete uterus relaxes again. This is the longest-lasting stage in the cycle, and the variation of the intensity of the reaction to rubbing is what indicates the phase of the cycle the uterus is in. It is symbolically represented by two interpretations that differ from each other based on the intensity: Slightly Strogenized Uterus, ULE1, characterized by a uterus that takes longer to respond to manual stimulation, slowly forming an erection with semi-tubular horns of flattened appearance. Rubbing intensely over and between the horns allows the complete rubbing of the fingertips until arousal forms a semi-tubular uterus that separates the fingers little by little as an erection begins. On the other hand, when rubbing stops, it relaxes quickly in the hand allowing the fingertips to rub over the complete horn effortlessly. This stage is also noted because the local rubbing of a part of the horn does not generate an erection that extends to the rest of the reproductive organ. The other sub-stage, ULE2 (Slightly Strogenized Uterus 2) represents a uterus that responds to the constant rubbing of the horns with a faster erection, forming a tube that separates the fingertips fast but, if rubbing stops, it relaxes in the hand. If touched in this stage without rubbing, allows the fingertips to touch each other effortlessly. The next stage of the uterus during the oestral cycle is when it is aroused, and the sole contact with it when trying to locate it causes a total erection that will not allow the fingertips to touch each other even at the first rub. This is symbolically represented as UE, Strogenized Uterus, differentiated from the two previous stages because, by simply holding the uterus in the hand it keeps it aroused, in a type of permanent uterine erection. Also, rubbing on any part of the horns causes the uterine erection to extend to the entire organ.

### Pregnancy

Gestation is the Physio-reproductive status of the uterus which is responsible for support in its midst to the embryo become fetus until the time of delivery. It is a process during which the uterus changes consistency, shape, size and position within the pelvic or abdominal cavity, according to the development of the fetal membranes and the fetus. The diagnosis is used to evaluate the reproductive efficiency of the female, the bull, and especially, of the strategy of reproduction of the herd, this is by natural or artificial means.

This process of changes of the uterus begins to be perceptible on palpation are developed when the embryo membranes that protect the fetus. Detected from very early stages, especially, the gravid Horn because membranes begin to flood the horns accumulating fluid. The gravid Horn is the first that is filled, then the other Horn, to the extent that advances the development of the pregnancy. The gravid Horn is the first that begins to change shape, size, consistency and content. This process also causes the uterus to accumulate weight, and that it fits in certain ways on the floor of the pelvis.

In this practice, as in all the following, we analyze first, generally speaking, the size and consistency of the uterus. This is carried out through the general rubbing, making a tour of the uterus, rubbing, in a coming and going of the hand and fingers, over and between the horns. If you do not notice any difference, it will proceed to do a thorough-scan consisting of travel, each horn separately; this is done by partially rubbing each part of the Horn with the index finger and the middle finger, starting from the base towards the tip. During this process, it is very important that the pads of the fingers only make light contact, without oppressing the wall between itself, is a technique that guarantees you to explore the content of the Horn without causing damage.

The first experience that can be detected on palpation, is when the fetus around it is a bubble filled with fluid, an early stage of gestation that you must feel very carefully. This bubble can be hosted in any part of the Horn, and must be located by exploring from the base towards the tip. This is done by gently rubbing the Horn between thumb and index fingers, trying to see inside a bubble. It is very important that when rubbing, are not pressed the Horn between your toes, they must move avoiding pressing the fingertips to each other, in such a way that you can feel the moment in which the fingers encounter with a floating structure that is round and smooth. It is a structure which can be perceptible from the thirty days of gestation.

The second experience which you may feel is a more advanced stage of pregnancy, when the bubble goes beyond the diameter of the Horn that hosts. Palpation is seen because the bubble expands, slimming and softening the walls of the site that hosts, a clear sense of bulging of the Horn and thinning of the walls where the bubble is implanted. This structure is perceived from the thirty-five days of gestation.

Past experience, is followed by another that has to do with the invasion of the pregnant Horn, with membranes and fetal fluids. At this stage, the gravid Horn grows diametrally and longitudinally, the wall distends, thins, and begins to notice a difference in size between the horns. There is a change in the consistency of the walls, a major shift in its content, and a clear imbalance because membranes and fetal fluids have invaded the gravid Horn. These features are beginning to be perceptible from the forty days of gestation, and the forty-five days, is very clear the difference in size between the horns; the diagnosis of gestation of this pregnancy time basically associated with the size and consistency of the gravid Horn.

During the previous phase and up to sixty days, the diagnosis of pregnancy can be done by combining the general touching of the uterus, with the partial in the horn of larger size; first explores in a general manner by analyzing size and consistency of the horns, until that is detected the of larger size, which, in addition to being bigger, is loose consistency and is not aroused to kneading it, then runs to the tip, touching gently, without oppressing the fingertips of the thumb and index fingers together, looking for the presence of the fetus. Despite the above, a proof that simplifies and certifies the pregnancy during this period, is that once detected the gravid horn through the general rubbing, it accommodates opposing thumb and index fingers in a flaccid portion of the Horn, preferably in front of the bifurcation, and already then is to detect the passage of the fetal membranes between the toes; It is done by pressing the horn to join the walls, without pressing, so that the pads of the fingers, only and reach to touch each other, then, he rubbed, very gently until that is perceived, that between the fingers, cross a few cords that are perceived as veins.

Another feature of this phase of the development of the pregnancy, is that the weight of the uterus it must fit on the floor of the pelvic cavity; the gravid Horn starts looping on yourself, and moves to the back of the left side of the pelvic cavity, to the extent that arriving at sixty days, stands completely behind, coiled so that it makes it difficult to get it out of that position. It is a unique positioning, serving as element of suspicion of pregnancy, so it is recommended, not to try to remove it, but make the diagnosis in that position, to apply to the slippage of the veins between the pads of the fingers.

After sixty days, the uterus begins to move again toward the center of the pelvic cavity, resting on the floor and then grows up to become a bubble of the size of a volleyball when he reaches ninety days. During this phase of development of the fetus, the diagnosis of pregnancy continues to be based on the size, consistency and content of the gravid Horn, as also in the detection of fetal membranes between the thumb and index fingers. But it is from the seventy days that another form of diagnostic that consists of making bounce the fetus against the hand can be used. It is accommodating the palm of the hand with the fingers extended on the part of the gravid Horn perceived more widened, and then is pushed, soft and rhythmically, forcing the stock market which protects the fetus to bounce and hit against the fingers. This technique, the rally of the fetus, facilitates the diagnosis to the extent that advances the gestation.

90 Days, the gravid horn takes the form of a ball, and at five hundred days began to lose this way, when it begins to fall into the abdominal cavity, is clearly seen how the uterus begins to invade the abdomen, the ball turns into an oblong bag, which upon reaching the hundred and twenty days, is big enough as it is to introduce all the arm into the rectum to explore all the contour of the SAC complete.

From the fourth to the fifth month, the uterus ends up accommodated fully within the abdominal cavity, the fetus settles down the belly without that is you can notice it, beyond the reach of the hand until that begins to emerge from the sixth month. While the calf falls into the abdominal cavity, the diagnosis is made by the size of the fetus until it is accommodated in the background, beyond the reach of the hand. When this happens, the position of the cervix and the strength to pull her towards the bottom becomes the evidence for the diagnosis of pregnancy and for the calculation of the time of the same, especially in the fifth month, because it hangs with such force that it does not move it from the place.

The fifth to the sixth month, the fetus begins to emerge, and the cervix begins to float in the abdominal cavity in a vertical manner, again it is possible to play for the calf, and the thickness of their bones also serves as an element of trial to determine the age.

Similarly, in the sixth to the seventh month, the diagnosis can be analyzing the position of the cervix in the abdominal cavity, and the thickness of the bones of the calf. During this period, the cervix begins to accommodate horizontally, but the size of the calf and the thickness of the bones, are the best indicators of the approximate age.

The next important change serving as an element of judgment to calculate the age of gestation occurs in the seventh month until delivery, the cervix begins to thicken and accommodate within the pelvic cavity, but the size of the calf and the thickness of the bones are the most important indicators to define the age.

### Post Delivery

The learning of the changes that occur in the uterus after childbirth is basically used to know the status of health or disease, so also, the path that takes the reproductive activity of the cow. During this process, the uterus returns to its bicorne form, the consistency of the walls is the main indicator of healthy nature, and once the size of the uterus regresses long enough to reach out to explore it fully, the reaction to the stimulus of the rubbing, and the thickness of the walls become indicators of the direction that takes the reproduction.

Two basic physio-reproductive States are recognized at palpation after childbirth: the first is used to assess the normal or abnormality of the delivery, and its importance lies in the early diagnosis for the prevention of morbid processes, because it is possible to perceive and differentiate the State of health and disease from the twenty-four hours after the birth. This phase includes all the time during which the Horn which contained the fetus returns to the shape and size of sexuality; (normally covers the first two weeks of postpartum, and is symbolically represented as any of the two following substatus): UPN: 1) normal delivery uterus. (Characterized by a State of total relaxation of the uterus, it manifests itself physically by the loose consistency in the uterine horn which contained the fetus during gestation). 2) UPA: abnormal childbirth uterus. (Characterized as an altered state of childbirth, it manifests itself physically by a thick consistency semirrigida wall, indicates that the uterus is initiating a morbid process that may be due to a retention of membranes or an infection acquired during childbirth). It serves to identify time morbid processes in order to prevent future reproductive failures.

The second physio-reproductive State of the cow after giving birth is used to predict the course that addresses reproductive behavior >its importance lies in knowing if the involution of the uterus returns to normal reproductive or if he is directed towards the anestro (to temporary functional regression of reproduction), are recognized basically sub-statuses: 1) UIN: uterus normal involution. It is characterized because the uterus returns immediately to the State of sexual activity after childbirth. This sub-status is evaluated from the end of the second week postpartum, refers to a uterus clearly influenced by the presence of follicles in the ovaries. Palpation is seen because the uterus reacts with an erection as soon as it is played, because the two horns react to the rubbing throughout, are quickly separating the rubbing of the fingertip also because while both horns are perfectly shaped to nest a new life, the horn that kept the pregnancy is of larger size because it has not yet finished developed to normal size. This State is especially important because it indicates that the female is in perfect balance, well nourished, and that it is genetically capable of producing a calf each year in the environment that it is found. Means that this cow is to enter in heat within thirty days.

(2) UIR: uterus regressive involution. It is characterized because the uterus indicates risk of temporary anestro. The severity or degree of reproductive damage is associated with anatomical and physiological status of the horns at the time that practiced the consideration, in general terms, the diagnosis is due to the extent the disproportion between the horns, and to the extent that each part or section of each of the two horns respond or stops responding to the stimulus of the rubbing. Within this sub-status are recognized only two variants:

(3) UR: uterus regression. Characterized because it announces the cancellation of all reproductive activity, it is especially important because it is the first sign of alarm that emits the female when walking towards the anestro, a turning point in the farm economy. This State is an unpleasant indicator which predicts that the female will not submit zeal during breastfeeding, because it is not nurturing correctly under the particular atmosphere that inhabits or in his case, which lacks the genetic ability to reproduce a calf each year. It perceives the palpation, because the Horn that kept the gestation period, even though you already have the size of an active Horn not pregnant, it does not react to any of the two forms of stimulus manual; its shape is perceived not tubular but rather flattened and clearly denotes that the thickness of the wall at the tip of the Horn is thinner, which is a classic symptom of the way in which the uterine immaturity manifests, tip backwards, as if they were drying; also, can one be accountable easily, because the other Horn is much shorter, very thin wall and loose consistency, without reaction anywhere; indicates that it was not developed or is in the process of developing is.

(4) UPRO: proactive uterus. This variant of perception is characterized and differs from the above, because the Horn that held the gestation, reacts to the rubbing in at least one section, while the other, may or may not react, but it is always of lower stature. This physiological state indicates ripeness is the uterus in the cow, which, unlike the calves, so whatever maturing a Horn of the other, used to predict the time it takes him to be ready to play again. This State is represented by a symbol closely associated with the activity of one or two horns, so you have UPRO1, refers to a uterus with only one of the two horns active, which can be for it to react to the rubbing throughout which is, or only in part, characterized by the great disparity in the size of the horns, being always the asset of much larger size and the only one which reacts to the rubbing in at least one section, while the inactive is a very small, flabby, Horn of very thin wall, indicated that the female will be ready to conceive again until the end of lactation, also points out, that in the conditions in which feeds, not lets play, efficiently or if which is genetically incapable of doing it. UPRO1-2, refers to a womb with a horn which reacts to throughout, and the other only in part; It is characterized for the disproportion between the horns is less pronounced, but clearly evident, because the boy or of lower stature, horn is also in the process of maturation, in the process of achieving the size and the thickness of the largest Horn; characterized on palpation, because at the time of rubbing the smaller Horn, this only acquired tubular shape in the mature side, while the immature part, looks like a flattened, the wall is thin and does not respond to the rubbing.

In general these two variables of the proactive uterus fisioreproductivos States, indicate a latency of reproduction led by a light nutritional imbalance or, where appropriate, genetic inability to reproduce under the environment that is found, which, in turn, serves as a reference of genetic selection for biological efficiency.

Finally we will describe the Physio-reproductive State of the uterus when the cow moves from proactive to the State that precedes the zeal, UPRO2, a successive and progressive State which all kidding female has to be to be able to conceive a new life. It is characterized because the touch of it while it is located, it generates an immediate erection which is maintained by the mere fact of holding it on the hand. A state that is physically characterized in the womb when the horn that may be develop the second is by the size of the horn that matures first. The two horns react to the rubbing with an immediate erection, and because the only smaller Horn lacks mature tip, the end of the Horn can only be where the fingertip, it perceives palpation because the wall is thinner and allows somehow to the rub the tips of the thumb to touch slightly with the index finger. This State is a clear indicator that the physio-reproductive activity of the female is finalizing the process of maturation of the uterus and in the process comes into estrus within 30 days.

Described all the physio-reproductive States not pregnant uterus, it is up to now explain the palpation procedure, because it is through him we can interpret what is happening at any given time. As noted above, the procedure of palpation of physio-reproductive State of the uterus is based on a technique of physical inspection of the uterus through the touch that evaluates two fundamental physical aspects: the anatomical that has to do with the size of the uterus and the differences or similarities in size thickness and thickness between the horns; and the physiological that has to do with the answer to the manual stimulation in each of the sections in which the uterus is divided to be analyzed. Both aspects are in turn closely linked with the process of maturity or immaturity of the uterus, and the intrinsic processes of reproduction.

This is the lesson of the awareness of the fingers to determine reproductive diagnosis. It is a technique of manipulation, exploration and tactile stimulation, which aims to meet the physio-reproductive for status: detect, prevent, predict, induce, programming and condition reproductive events f economic importance to the farmer.

This practice is designed to study the formula to learn how to analyze the behavior of the uterus, and the way to analyze the anatomical differences between the three sections should be discussed.

There are three ways that you can get information; a, is studying the behavior to the stimulus of the rubbing, other, studying the conformation of the uterus, and the third, a combination of both.

1st. Study of the behavior of the uterus to the stimulus of the rubbing. It is focused on the analysis of the physical manifestations that are used for interpreting the physiological status of the reproductive system. It serves to clarify the status of maturity of the uterus, to specify the phase of the estrous cycle, the ovarian status and to determine the health of the uterus.

The rubbing, in turn, is a technique of stimulation that is applied in two basic ways:

(a).—General. It is a technique of exploration and tactile stimulation to get information from the corporeal nature of the uterus, is how it is made and how it behaves as a body. It is rubbing the contour of the uterus, caressing the surface in a coming and going of the hand between the cervix and the tip of the horns.

(b).—partial. It is a technique that applies in a particular segment of the matrix, it serves to clarify the information of the corporeal nature of the uterus. Carried out, first, placing the fingers in the part of the uterus to analyze, positioned with the index finger and middle fingertips conflicting to the thumb correctly. It is a technique that part of the attempt to rub the uterus between the fingers in order to clear these fingertips each other.

2nd. Study of the formation of the uterus. It is used to determine the approximate time of the pregnancy, postpartum, abortion and the status of immaturity of the uterus. Carried out by means of the technique of general rubbing, analyzing shape, size and muscle tension.

3rd. The combination of both techniques. Precise anatomical status, the physiological and reproductive health. It integrates reproductive diagnosis.

This first practice is recommended to start with sexually active heifers, to study the various manifestations of the uterus at rest, and to study the reaction or not to the stimulus of the partial and general rubbing.

The first step to acquire experience in the art of felt, is sure to study the status of the uterus in a State of rest, before being overused, given that it is the first indicator of the State in which it is. It recommends:

. 1—Locate the site where the reproductive organ to know beforehand the place where should tempt her.

2Nd.—left hand completely still, as close as possible to the uterus, to avoid contractions while relaxing completely straight, giving time and opportunity, so that the matrix to relax, so that to tempt her, is can one give an account of the status at rest before being stimulated by the continuous contact of the hand.

At rest, there are two very different statuses among themselves:

(1)—Flaccid, with or without tube configuration. This perception of the status of the uterus at rest is enticing slow and very gently the back of the uterus with the index fingertip and a half, in zigzag from the base of the horns to the bifurcation in an attempt to define the configuration of the horns and the uterus itself, i.e., if the enticing is or is not a tubular defined.

(2)—Erect. This status of rest can only be found under two conditions very specific of the uterus; which is of utmost importance is that it is associated with infections during the postpartum and infectious abortion, is a State especially associated with pathological inflammation of the uterus, is characterized by their marked semirrigida tubular configuration, with the tense and thick muscular wall. The other physiological event that manifests itself with clear tubular configuration during a State of rest, occurs during the fertilization of the ovum, feels a natural and intense erection force and health.

The next step to acquire the necessary skill, is analyzing the configuration and receive the response from the uterus to be rubbed partially, so, it is essential to bear in mind that the sensitivity depends on the subtlety as it moves the fingers, because they transmit information. If the buds just rub the part being evaluated, and if it moves them freely with delicacy. This study can be in any part of the uterus, but it is recommended to start at the base of the horns. Carried out by placing competing and a half against the thumb and index fingers trying to perceive before rubbing, the natural configuration of the part of the uterus that is analyzing, cylindrical or amorphous; later, in an attempt to brush the fingertips, perceive, if to rub for the first time, it allowed or not, the pads of the fingers to rub each other; later, to continue rubbing, it is necessary to be attentive to perceive if to the extent that he rubbed, begins to settle as a tubular structure that separates little by little the rubbing of the fingertip.

Finally, another element of analysis of the behavior of the uterus is learning to perceive, if in the event of local rubbing, the tubular formation extends beyond the part that is rubbed. It is an indicator that assesses the degree of excitation of the reproductive organ, and its diagnostic value lies in the hormonal activity, especially with the presence of hormones that regulate sexual activity.

Once practiced this, continued study and analyze the thickness of the walls, for it is necessary to move the thumb and index fingers down to the shore of the uterus, positioned so that to the crimp, it gather the walls only long enough for that to move the fingers together. It manages to perceive the thickness of the muscle that is.

Finally, and only once, that manages to perceive various ways and forms of behavior of the uterus to the partial rubbing, it is up now to learn to perceive the formation and behavior of the uterus to the general rubbing. Is sliding the hand from the base of the horns to the tip, in a come and go hand in hand to assess the size, the symmetry or asymmetry between the horns, their degree of arousal or erection induced in little, much, or nothing.

This first phase of the art of felt, must be practiced, on at least 20 females, sexually active; 10 heifers and 10 cows pluriparas, to give opportunity to analyze the size and configuration of the uterus at full maturity, also the various ways how it behaves to be stimulated as partial and general, as this, no doubt. It will help, later on, clarify the reproductive diagnosis.

This process is made manifest to the touch because the uterus which has begun to ripen responds in a manner more than noticeable with an erection to the stimulus manual tempt him rubbing in a coming and going of the fingers, sliding them over its entire surface, and the stimulation of the local rubbing sections between the fingers, thumb, index and/or middle. This default to explore and to manually stimulate has the particularity of read first the natural consistency, then, reaction or no reaction of the uterus, and in the end, realizing the size, and the differences, if any, between horns when we do carefully detail exploration of the uterus section by section.

It is characterized for the initial assessment that what we must do at the moment of touch is on the natural status of consistency that is the uterus, which may be of total flaccidity, light or intense activity estrogenic pro, and inflammation processes infectious and/or abortion; second is to measure the size of the uterus to find out what possible physio-reproductive State we are, if we are with an immature animal sexually, if we are with an animal in the process of sexual maturation, if we have a mature animal sexually whether we are with a mysterious animal, or whether we have an animal in the process of post-partum; Act followed, is to make a general assessment of the uterus sliding the hand on the uterus from the base of the horns towards the tip looking for similarities or anatomical differences between the horns; and, finally, is a recognition of thorough in each of the three sections that we divide the uterus, with a technique of very particular rubbing that allows to inspect, analyze, interpret and clarify the exact physio-reproductive State of the female that you practiced review. What is happening and what will happen.

It is a technique of rubbing the thumb against the index as part of the attempt of touching the fingertips when they position themselves competing between the uterus. This technique measures the degree of response to the stimulus of the rubbing with the speed with which separates and prevents the pads of the fingers to rub, and allow subjectively measured the thickness of the walls. It is a procedure to be performed, by sections, always starting from the base of the horns, rubbing both horns at once if it is a female virgin which is under consideration, and preferably every Horn separately if it is a cow, because the womb of an animal than his and that he is preparing again to conceive, manifests itself differently from that of the calves or novillonas, however in both cases always should be evaluated by sections, rubbing in fan with your thumb, gently on both horns at once, in an effort to rub with the tips of the index finger.

This particular form of take and explore the first section of the uterus, where the horns remain united, allows to first assess the natural consistency of the uterus before rubbing, secondly to assess the reaction to the stimulus of the rubbing, and thirdly, to assess if both horns are similar, or if there are differences in thickness, content, thickness of the walls, consistency, and in reaction. It serves to anticipate with possible state pysio-reproductive we are blocked, and the simplest way to know is that after having analyzed consistency and reaction, discusses the symmetry or asymmetry between the horns at the time of going to explore them because the cases that are symmetric obey physio-reproductive States relating to the maturation of the uterus of heifer and the estrous cycle of cows or heifer. The cases that are asymmetrical, any palpable difference, are due to any of the following States:

(a). the State of involution of uterus after childbirth. Because the involution of the uterine horn that kept the pregnancy creates a disproportion between the horns throughout the process of auto regeneration to the normal size of sexuality.

(b). the State of maturation of the uterus of a cow that is preparing again to conceive because the development of the uterine horns is asymmetric.

(c). the State which he continues to heat before ovulate. Because the Horn with the ovary that is going to ovulate is excited and becomes slightly larger diameter.

(d). the State of gestation early because the pregnant Horn grows slimming the wall where the embryo is implanted and generally perceived semi-full with fluid.

(e). the State of abortion because the involution or return of the Horn to functional normalcy creates asymmetry.

(f). to the State postpartum infectious disease because the affected Horn ignites.

(g). the State severe postpartum temporary anestro, because the functional regression of the ovarian system creates asymmetry in thickness and thickness of the horns.

Now, insofar as it refers to the exploration of the second section of the uterus between the external bifurcation and the tip of the horns, began positioning the thumb on the bifurcation, holding both horns on the index finger, middle and ring. This particular way of positioning on the bifurcation allows to evaluate the consistency, primarily because the horns can be slack, swollen, excited, or filled with fluid, second, the reaction at the time of rubbing them, because they can be or not to react when they are stimulated with the touch of the fingers, and thirdly, compare the thickness and the thickness of the horns, because if there are differences in thickness between the horns, and were not detected in the first section, it is one of two following States:

(a). the State of maturation of the uterus of a cow that is preparing again to conceive because the development of the uterine horns is asymmetric.

(b). the State which he continues to heat before ovulate. Because the Horn with the ovary that is going to ovulate is excited and becomes slightly larger diameter.

(c). the State of gestation early because the pregnant Horn grows slimming the wall where the embryo is implanted and generally perceived seedlings with fluid.

(d). the State of regression sexual of the cow because the anestro in all its facets creates asymmetry between the horns.

Thus, once explores size, consistency, the reaction and the thickness of the walls of the horns in the bifurcation, and only if we do not get a clear reading of the physiological state that this is because we did not find differences is to make another comparative measurement in half of the curvature of the horns, exploring with the thumb fingers and index each Horn separately, while progress up to the greater curvature, where the horns are taken as shown in the FIG. E, in order to make a new analysis of differences in thickness, thickness of the walls, consistency, and reaction, in order to determine the State Physio—reproductive. At this point in the exploration of the uterus, the differences found only may be due to any of the following two States:

(a). the State of maturation of the uterus of a cow that is preparing again to conceive because the development of the uterine horns is asymmetric.

(b). the State of early pregnancy because pregnant Horn grows slimming the wall where the embryo is implanted, is perceived with the feeling of touching a bulge with fluid which increases the size of the Horn in a segment that is characterized by the thin wall.

As well as, and only if in the greater curvature we cannot establish the diagnosis, because we did not find differences, is to continue along the horns separately the tip, exploring and analyzing each part until finally we are positioned in the curve that precedes the tip to compare size, reaction and consistency, in order to be able to establish a diagnosis must, it can be, depending on whether or not differences, because if it is, and the main difference points to length of the horns, is because the uterus is under construction, in the process of maturation; However, if the main differences point to dimension, the content, and consistency, surely it is because it's a pregnancy sooner; Finally, and only to not find differences in this part of the uterus, because the horns have the same dimension, the same consistency, and the same response to the stimulus of the rubbing, we must think about a fully mature uterus that, depending on the reaction, we could set the stage of the estrous cycle in which the animal is under the consideration.

Finally, play now explain the exploration of the third and final section of the uterus, which corresponds to the oviducts, his analysis is especially used to detect chronic diseases, generated most of the time, by a process altered birth or for an abortion, it is the section where old diseases are detected, where you can see if the animal is healthy, or if you have an old process, infectious. Which is found easily by comparing the size and consistency between the oviducts, just to one inch of distance from the end of each Horn, because the sick uterus side is more thick, firm and inflexible, consistency while the healthy side is more slender and flexible.

Given to this technique of palpation allows to specify the hormonal activity relating to the reproduction because each Physio-reproductive State is correlated with the presence of one or more hormones interacting in specific joint activities, we will describe how they manifest and are perceived. They are easily identified by the activity they generate in the womb, and because the concept of maturity of this body divided the hormonal activity only in two blocks: the first relates to the entire process of development and maturation of the womb of a virgin female or of a calved cow just up before that they enter in zeal for the first time, comprises the States of pro-activeness of the uterus: UPRO1, UPRO1-2 and UPRO2, connected with the activity of the hormone follicle stimulating (FSH) to grow and develop Graff follicles in the ovaries to induce them to generate hormones that have to do with the growth and development of the uterus, with the maturation process, which is preparing the uterus to conceive; the second block of hormonal activity lies with the States that have to do with the estrous cycle, divided in turn into five phases perceptible to the touch, comprises all the States of sexual activity of the uterus: UCR, ULE1, ULE2, EU and UC associated with the presence or absence of the hormone FSH, LH, progesterone, prostaglandin F2 alpha, and estradiol. Hormones which can give account that surround the characteristics of each of the Physio-reproductive States of the estrous cycle in the blood. Thus, when the uterus is detected as recent zeal, UCR, during the first 4 to 7 days after ovulation, depending on which as short or long is the single estrous cycle, it is relaxed and shows no reaction to the rubbing because ovarian activity is focused on developing the corpus luteum at the direction of the hormone luteinizing, LH, is a clear indicator of the hormone of the animal in question status, because the reaction to the rubbing is an indicator of the lack of estrogen, and the absence of this hormone is in turn a follicular status indicator which in turn reflects the latent state of FSH hormone. Now the next phase of the estrous cycle begins when the follicular influence begins to manifest itself in the uterus as a local reaction of the site of the horns which are rubbed, at this stage it is clear that the reaction is located and that it does not extend to the rest of the uterus. It is also clear that when you start to rub, the pads of the fingers rub without much effort until that local erection manages to separate them while still rubbing, why if you stop rubbing, the uterus is relaxed immediately on hand. Thus, the reaction of soda from the uterus to express a very slow erection shows us on the one hand low but evident influence of iatrogenic activity of the follicle, and by the side of the immediate relaxation, the influence of progesterone. The next phase, UL2, is a stage that is different from the previous because the response of the uterus to the rubbing is much more clear and firm, but not immediate, characterized by the constant rubbing of the horns produces an erection that extends throughout the body while still rubbing at this stage the estrogenica activity clearly by the erection, which is characterized because at the beginning of the rubbing, it allows the pads of the fingers to rub at least once before the horns from acquiring the typical tubular form of a uterine erection which prevents that the fingers can brush; Another typical feature of this State is that the erection ends on hand to rub, which is a clear demonstration of the influence of progesterone released by the corpus luteum. The next and penultimate phase of the estrous cycle, EU, estrogenizado uterus, differs from previous ones because the mere fact of touching the uterus to try to locate it, generates an immediate erection which does not allow the fingers to rub once trying to rub also because merely holding on the hand to the uterus, causing that this body is kept erect, and is precisely this feature the main indicator of the hormone dominance estrogenica, and notice that the uterus starts to produce prostaglandin F2a for inhibit the production of progesterone that is perceived precisely because the uterus does not relax, but that remains erect. This phase lasts several days, and the time always is going to depend on that as long or short is the single estrous cycle, at this stage the production of estrogen reaches its climax minutes before the animal accepts her copula for the first time, because once you agree to be mounted, and the animal enters State of zeal, is a hormonal change which manifests itself in the uterus as a decrease in the intensity of the uterine erection which is different from the previous phase because the mere fact of holding it already isn't enough to keep it erect, but that it is necessary to move it or touch it softly to keep you stimulated, thus, UC, uterus in zeal, is the final stage of the estrous cycle, exists all the time that the female remains accepting copula, and continues until it ends the process of ovulation, this State is characterized because after finishing the zeal, the Horn with the ovary with the dominant follicle gets excited easily and becomes of greater diameter than the other, in a manner such that does not allow that the fingers to rub, rub, while the other Horn, does not react, and if you allow the fingers to rub without much effort, this State lasts several hours after the heat until a new physiological event stops the estrogenica activity and creates in the Horn that was manifested before erection each that are rubbeda State of relaxation that ends by allowing that the pads of the fingers to repeatedly rub effortlessly, making this fact in the impending order that gives way to the process of ovulation, which correlates with the clara

This technique of palpation is also an indicator of the ovarian State and this is because the behavior of the uterus are feeds of ovarian function, at the same time allows you to know, without feeling the ovaries, which structures functional are the ones at this time, which provides a lot, because the concept of maturity of the uterus, divided into two blocks ovarian activity: the first relates to the ovarian status which has to do with the process of maturation associated with the States of pro-activity in the womb of the virgin female and the cow created before entering zeal by First, UPRO1, UPRO1-2 and UPRO2, because one thing is very true, that while the uterus does not complete its maturation, the only thing the ovaries may have are follicles, precisely because these are responsible for producing the hormones needed to finish developing it, so, while the horns are not matured, the physiology of reproduction only will dedicate to finish to do so, because in the time/space, works by priorities, the first of all, prepare the uterus for designing, as well as in all these States Physio-reproductive the ovaries of the virgin females who have not attained to mature the uterus, can only have follicles, and in the case of calving cows, too, but with the caveat that some have inactive luteum bodies called bodies albicans that, only they can differentiate from a corpus luteum active, precisely because the latter can not exist if horns have not yet reached full maturity. The second block of ovarian activity, is which refers to the status of continuous change in the anatomy of the or of the ovaries during the progressive stages of estrous cycle, UCR, UL1, UL2, EU, and UC. Thus, when we talk about UCR, a mature uterus does not react, and that is completely flaccid, is because there is no activity estrogenic, which indicates the absence of follicles at/or in the ovaries, and the absence of discernible luteum bodies because in this state the hormonal activity is focused on the development of the bleeding body within the cavity ovulation, which allows us to know that, regardless of the size and shape of the ovaries of the female which is practiced with the review, the ovarian status that corresponds is, in the case of an animal that operates ovaries in alternate cycles of the same size with a smooth surface, now, in the case of animals with unilateral estrual cycles, i.e. to which only works an ovary, ovarian status we can find, regardless of the size and shape of the ovaries, it is an ovary that triples the size of the other, but both with a smooth surface. However, the following status carcinoma that is apparent in the estrous cycle is it that corresponds to a slightly estrogenic uterus, UL1, here, an ovary, and the two occasionally, begin to develop one or more secondary follicles, while on the surface of the ovary where ovule, in the majority of cows and heifers, the ovulatory cavity has been completely filled out by a structure that emerges as a woman's nipple, a lump called hemorrhagic body, a corpus luteum tender characterized because it is easy to bend your pushing it gently with the tip of the index finger, in order to drop it, returning to its original position, with the feeling of vibrate. The next phase, UL2, is how we know according to hormonal cycles, ovaries which can receive one or more tertiary follicles and a corpus luteum firm and immovable, in this State, regardless of the ovarian genotype, the likes and the individual naturally the ovary possessing the corpus luteum is of larger size that the other and its shape is irregular, especially in those animals which only works an ovary. Still at this stage a totally estrogenizado uterus, EU, which, as we also know of agreement with the natural and individual, hormonal cycles corresponds to ovaries with presence and perception of a clear dominant follicle accompanied by secondary and tertiary follicles most of the time, and since then a firm luteum usually found in the other ovary, slightly larger size if the animal subject to the review is of estrous cycles alternating, and very large proportion of 3 to 1, in the case of animals than their estrous cycle is unilateral. Now, when the animal subject to the review is in heat, UC, what we are going to find in the ovaries in the case of an animal with alternate estrous cycles is that who has the dominant follicle, generally is of larger size because as it is known, the corpus luteum is in the process of care consumed and will reduce its size until that disappears when ovulation.

Another aspect that we are going to play is that it refers to practices zootechnical that derive from the reproductive study, in particular to the management of food and livestock depending on the individual and collective Physio-reproductive status of the herd, characterization to evaluate the genetic reproductive potential in relation to the system of care and particular power of the environment where it is found or live animals. Thus, when a herd of breeding we are calved cow, States physio-reproductive that indicate biological efficiency, uterine maturity, means that our animals are being treated and fed adequately to maintain efficient production cycles, but if, on the other hand found in lesser or greater degree, uterine immaturity, it is clear that something is wrong, and that something only may be due to two things, inefficient power supply, or genetic inability to reproduce efficiently under the environment that is found. And this is something that can easily assess you because if the herd or cow look healthy, well-nourished, it is clear that the constraint is a genetic echo, factor for other serious because we must not erode us economically trying to fight against nature. We're never going to win, and this is especially mentioned because in the tropical regions of the world they are still trying to produce milk and meat with races that are not designed to withstand without that which are impairing health, climate and the variety of external and internal parasites. However, and notwithstanding the above, the majority of the herds of the world, always going to find efficient cows and cows are not capable of reproducing cyclically, and this allows us to assess, depending on where the balance will tilt, if it becomes a tool of genetic selection allows us to assess our animals not only genetic ability pattern as livestock to evaluate other than productive efficiency, milk or meat, we can perceive with your fingers if there is or not a reaction, then if it stimulates or transforms a gut of flaccid to a tubular structure that consistency to the form, separates the fingers to rub it, preventing that the tips of the thumb rubbing with the yolks of the index finger and middle informing that this section is mature or if it is maturing. This perception is the one that tells us if only a part or all of the uterus is mature, and the particular technique of assessing the development of the uterus of a female, in future, will allow us to know how much of the uterine horns has developed, and that both lack them developing to an approximation of the time that will take to complete its development until it begins to cycle for the first time.

What is claimed is:

1. A method to palpate cows or heifers comprising the steps of:
determining a uterus consistency;
determining the uterus size to see the physio-reproductive state of the uterus;
touching the uterus by sliding a hand over the uterus from a horn base to a horn tip to determine the similarities or anatomical differences between the horns to determine which of the horns this active; and
touching the uterus to determine how the active horn reacts.

2. A method of breeding diagnosis that includes the following:
A) explore and stimulate the female reproductive organ; by default
(B) correlate the consistency, size, thickness, and reaction of the uterus to the default; stimulation
(C) detect anatomical uterine; Horn status
(D) detect the levels of development of uterine;
(And) detect the physiological response of the uterus to the stimulus default; and
(F) detect levels of maturity of the horns uterine.
